(19) United States
(12) Patent Application Publication
(10) Pub. No.: US 2002/0150509 A1
(43) Pub. Date: Oct. 17, 2002

(54) Laboratory specimen sampler with integrated specimen mount

(76) Inventors: Erik C. Houge, Orlando, FL (US); John M. McIntosh, Orlando, FL (US); Larry E. Plew, St. Cloud, FL (US); Fred A. Stevie, Orlando, FL (US); Catherine B. Vartuli, Windermere, FL (US)

Correspondence Address: HITT GAINES & BOISBRUN P.C., P.O. BOX 832570, RICHARDSON, TX, 75083, US

(21) Appl. No.: 09/836,525

(22) Filed: Apr. 17, 2001

(51) Int. Cl. B01L 3/00; G01N 1/02

(52) U.S. Cl. 422/99; 422/100; 73/864.91

(57) ABSTRACT

The present invention provides a sampler for collecting a specimen of a substance. In one embodiment, the sampler comprises a sampler body, a platen having first and second opposing sides wherein the first side is coupleable to an end of the sampler body, and a sampling medium coupleable to the second side and configured to retain a specimen of a substance thereon.

### TECHNICAL FIELD OF THE INVENTION

The present invention is directed, in general, to a laboratory specimen sampler and, more specifically, to a sampler for collecting specimens for laboratory analysis from a surface wherein the sampler comprises an integrated specimen mount and to a method of manufacturing the laboratory specimen sampler.

### BACKGROUND OF THE INVENTION

Particle contamination is a major cause of defective products in a modern semiconductor fabrication laboratory. Engineers regularly submit particle-covered wafers for laboratory analysis to determine the source of the contamination. Additionally, particles and residue from the inside, e.g., walls, floors, etc., of the manufacturing chambers are regularly analyzed to identify the type of contaminant and, hopefully, the source. However, transferring the suspect material to the analysis lab without contaminating the sample with other elements, such as: sodium, chlorine, potassium, calcium, etc., from human skin, the specimen holder, or simply from the air outside of the cleanroom is critical to identifying the contamination and its source.

The present cleanroom method for collecting sample contaminants from a semiconductor manufacturing tool involves providing the manufacturing engineer with a small, clean wafer container with a small piece of double-sided silver or carbon tape or indium foil. The engineer is instructed, when in the cleanroom, to: (a) remove one side of the protective backing from the tape/foil, (b) press the exposed side of the tape/foil to the contaminated surface, and (c) return the tape/foil to the analysis laboratory in the wafer container.

The quality of the sample thereby collected is directly related to the care with which the sample tape/foil is handled by the manufacturing engineer. That is, if the exposed adhesive of the tape/foil is touched with a glove, tweezers, skin, etc., the sample can easily be contaminated, thereby compromising any laboratory analysis. Additionally, once the sample is returned to the analysis laboratory, the tape/foil may again be compromised during the mounting process to prepare the sample for analysis in equipment such as: a scanning electron microscope, etc.

Accordingly, what is needed in the art is a device that collects a specimen of a contaminant from a surface and eliminates or significantly reduces the opportunity for human mishandling or contamination of the specimen through the analysis stage, thereby avoiding the limitations of the aforementioned method of collecting specimens.

### SUMMARY OF THE INVENTION

To address the above-discussed deficiencies of the prior art, the present invention provides a laboratory specimen sampler for collecting a specimen of a substance. In one embodiment, the laboratory specimen sampler comprises a sampler body, a platen having first and second opposing sides wherein the first side is coupleable to an end of the sampler body, and a sampling medium coupleable to the second side and configured to retain a specimen of a substance thereon.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

The invention is best understood from the following detailed description when read with the accompanying FIGUREs. Reference is now made to the following descriptions taken in conjunction with the accompanying drawings, in which:

FIG. 1 illustrates an exploded partial sectional view of one embodiment of a laboratory specimen sampler constructed according to the principles of the present invention;

FIG. 2 illustrates an exploded partial sectional view of an alternative embodiment of a sampler constructed according to the principles of the present invention;

FIG. 3A illustrates a partial sectional view of the sampler of FIG. 2 as assembled and provided to a technician responsible for retrieving a specimen of a suspected contaminant from a surface;

FIG. 3B illustrates a partial sectional view of the sampler of FIG. 2 being prepared to retrieve a sample of a suspected contaminant from the surface;

FIG. 3C illustrates a partial sectional view of the sampler of FIG. 2 just prior to retrieving the specimen of the suspected contaminant from the surface;

FIG. 3D illustrates a partial sectional view of the sampler of FIG. 2 with a specimen of the suspected contaminant;

FIG. 4 illustrates an exploded partial sectional view of the platen, sampling medium, and specimen after removal from the sampler body and proximate a holder for a generic analysis tool;

FIG. 5A illustrates a partial sectional side view of an alternative embodiment of the sampler of FIG. 1 as it would be stored and carried; and

FIG. 5B illustrates a partial sectional side view of the embodiment of FIG. 5 as it would be in use.

### DETAILED DESCRIPTION

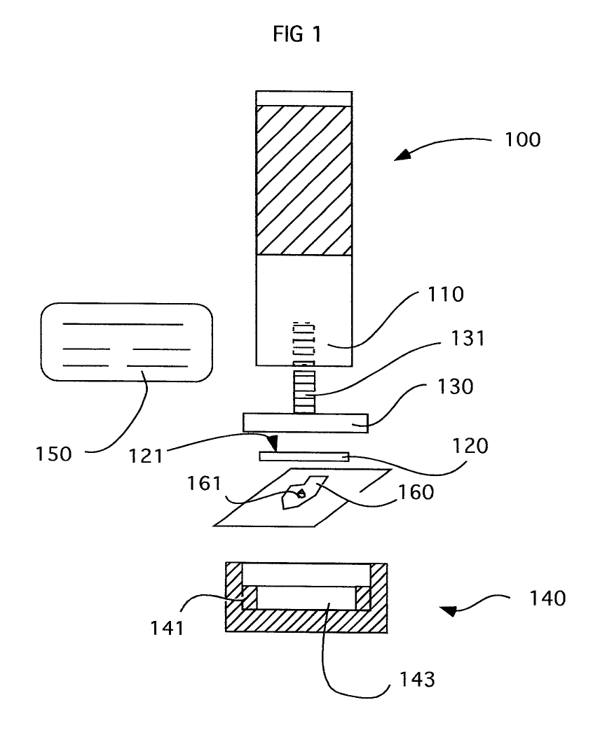

Referring initially to FIG. 1, illustrated is an exploded partial sectional view of one embodiment of a laboratory specimen sampler 100 constructed according to the principles of the present invention. In this embodiment, the sampler 100 comprises: a sampler body 110, a sampling medium 120, a platen 130, and a platen cap 140. The sampler 100 is proximate a substance 160 from which a specimen 161 will be taken. The sampler 100 may further comprise a self-adhering identifying label 150 to identify time, place, operator, etc., regarding the specimen 161. The sampling medium 120, which may be a foil or foil tape comprising indium, silver, carbon, copper, gold, or other suitable medium, is coupled to the platen 130. More specifically, foil tape made from indium may have an adhesive layer 121 that adheres the foil tape 120 to the platen 130. Indium is desirous as a sampling medium 120 in silicon semiconductor manufacturing because of the ease with which it may be identified in analysis of a specimen and the fact that it is an uncommon element, thereby easily disregarded as part of the sampling system, and not part of the specimen. Of course, other sampling mediums may also be used with the present invention to obtain specific advantages that the other sampling mediums may provide in particular situations. The platen cap 140 protects the sampling medium 120 from inadvertently acquiring contaminants (not shown) during storage and handling. One who is skilled in the art will recognize that the platen cap 140 may be held to the sampler body 110 in a variety of ways, e.g., friction fit, matching bosses and detents, etc. The platen cap 140 comprises a platen stop 141 and an aperture 143. When the platen cap 140 is in place on the sampler body 110, the platen 130 rests against the platen stop 141 and the sampling medium 120 rests in the aperture 143.

To operate the sampler 100, the platen cap 140 is removed from the sampler 100 and the sampling medium 120 pressed against the substance 160 whereby the specimen 161 adheres to the sampling medium 120. After the specimen 161 has been acquired, the platen cap 140 is replaced on the platen 140 to protect the specimen 161 and sampling medium 120 from contamination, either human or environmental. Thereafter, the entire sampler 100 and specimen 161 may be delivered/entrusted to a technician for laboratory analysis. In one embodiment, the sampler body 110 and platen 130 may be integrally formed. Ideally, the platen 130 is removable from the sampler body 110 depending upon the attachment method. That is, the platen 130 may be screwed or mechanically coupled to the sampler body 110 in any way suitable. In the instance of an integrally formed sampler body 110 and platen 130, the juncture of the sampler body 110 and platen 130 may be designed with a breakaway joint wherein the platen is designed to mount directly to a selected analysis tool. Of course, the method of attachment is tailored to an analysis tool (not shown) intended to be used on the specimen 161. That is, if the intended analysis tool is a scanning electron microscope (SEM), then the same method, or a compatible method, of mounting the platen 130 to the sampler body 110 as is used to mount the platen 130 to the SEM should be designed into the sampler 100. Therefore, individual samplers 100, particularly the mounting method of the platen 130 to the sampler body 110, may be designed to accommodate interfacing with a particular type or model of analysis tool. For example, the platen 130 may have external threads about its periphery (not shown) or may be mounted by a threaded stud 131 extending into and coupling to the sampler body 110 as shown.

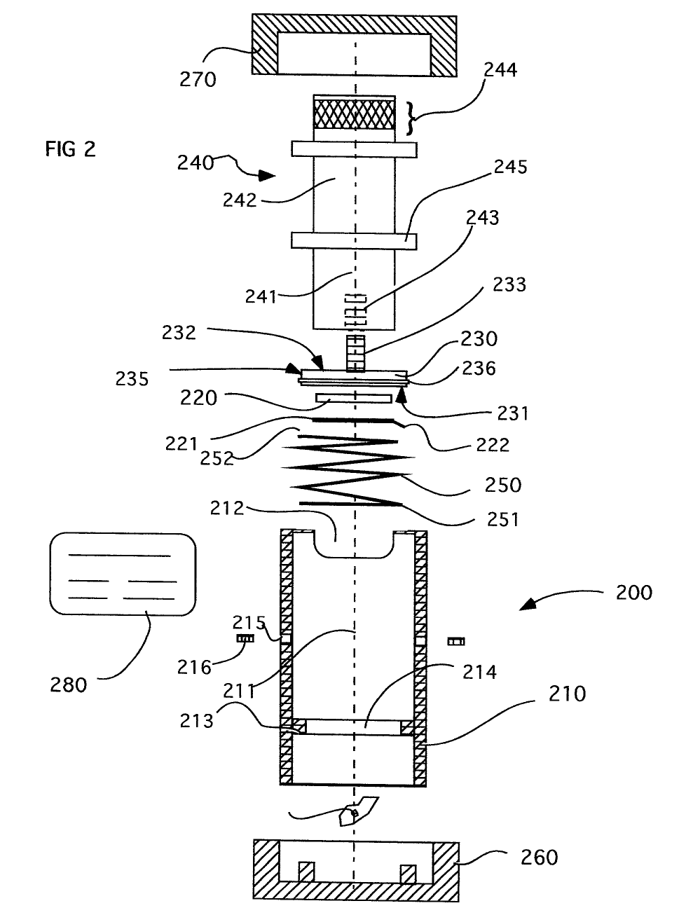

Referring now to FIG. 2, illustrated is an exploded partial sectional view of an alternative embodiment of a sampler 200 constructed according to the principles of the present invention. The sampler 200 comprises: a sampler body 210, a sampling medium 220, a platen 230, a plunger 240, a spring 250, a specimen cap 260 and a security cap 270. The sampler 200 is accompanied by an identification label 280 coupleable to the sampler body 210. The sampler body 210 has an operating axis 211 that is coincident with a longitudinal axis 241 of the plunger 240 when assembled. A finger access 212 is shaped in the sampler body 210. The sampler body 210 has an inner spring support 213 upon which a first end 251 of the spring 250 rests. The plunger 240 passes through a plunger aperture 214 in the inner spring support 213. The sampler body 210 has restraining lug apertures 215 formed therethrough that accept restraining lugs 216 for restraining the spring 250.

The sampling medium 220 comprises a double-sided tape or foil of silver, carbon, indium, copper, gold, or other suitable medium depending upon the environment from which a specimen is to be taken and the physical properties of the sampling medium 220. That is, in a semiconductor manufacturing cleanroom, the sampling medium 220 could be a piece of indium foil that would readily adhere to a sampling surface 231 of the platen 230. In this case, indium is an element not likely to be found anywhere else in the cleanroom, thus, any indium traces that show up during analysis of a specimen could be dismissed as part of the sampling medium and specimen mounting system. In other environments, such as at a crime scene, the sampling medium 220 could be a piece of silver tape. In a like manner, traces of silver that are evident during analysis of a crime scene specimen could be eliminated from consideration as part of the sampling medium. Of course, those who are skilled in the art are familiar with other materials that may likewise be used effectively with the present invention. The sampling medium 220 may also comprise a removable seal 221 having a peel tab 222. In one embodiment, the removable seal 221 is an inert covering protecting the sampling medium 220 from inadvertent contamination during storage and transportation prior to sampling. One who is skilled in the art is familiar with the principles of double sided tape wherein one side may be used to attach the tape to the platen with the second side remaining covered by a removable protective seal.

The platen 230 comprises a material such as: aluminum, plastic, etc., that is easily worked to a suitable configuration and that is compatible with the intended analysis tool. The platen 230 material is also selected to be readily identified in an analysis laboratory, e.g., spectrometer, etc., as being part of the sample mount and not a contaminant. Specific analysis tools with which the sampler 200 may be made compatible include but are not limited to: a scanning electron microscope (SEM), an Auger electron spectrometer (AES), a focused ion beam (FIB), or an X-ray reflection diffactometer (XFD). The platen 230 comprises a first side 231 and a second side 232. The platen 230 further comprises at least one mounting system compatible with the intended analysis tool, e.g., for a SEM, the platen 230 may comprise a mounting stud 233 that is matched to an internally threaded aperture (not shown) of the SEM. Of course, an internally threaded aperture 243 of the plunger 240 must thereby be matched to the mounting stud 233. Alternatively, the platen 230 may also incorporate other methods to mount to an analysis tool, e.g., external threads (not shown) about a periphery 235 of the platen 230, a prescribed periphery shape (e.g., hexagonal), etc. One who is skilled in the art will also recognize that the illustrated platen 230 also incorporates a shoulder 236 that may be used to restrain the platen 230 when inserted into a mounting aperture (not shown) of an analysis tool. In fact, the platen 230 may be configured to be compatible with the mounting systems of more than one analysis tool, as shown, depending upon the specific mounting requirements of various analysis tools that are mutually compatible. Alternatively, the platen 230 may be adapted for a specific tool by employing clips, tape, double-sided tape, etc.

The plunger 240 further comprises a central spindle 242, a knob 244, and a spring collar 245. When assembled, a second end 252 of the spring 250 bears against and is retained by the spring collar 245 and restraining pins 216, thus enabling the spring 250 to urge the platen 230 toward the finger access 212 end of the sampler body 210 and away from the specimen cap 260 thus assuring that the sampling medium 220 does not inadvertently touch any surface not desired. The plunger 240 is coupleable to the platen 230 at the second surface 232 and the sampling medium 220 is coupled to the first surface 231. The plunger 240 and the platen 230 are slidably coupled to the sampler body 210 in such a way that the plunger 240 and platen 230 move together along the operating axis 211. The specimen cap 260 is removably coupleable to the sampler body 210 so that when the specimen cap 260 is removed, the sampling medium 220 is retracted within the sampler body 210, but is capable of being exposed. Part of the second surface 232 may also be exposed when the specimen cap 260 is removed, however this does not limit the functionality of the sampler 200. When in place, the security cap 270 prevents access to the knob 244 so that the platen 230 and the sampling medium 220 are prevented from inadvertent exposure and contamination. One who is skilled in the art will realize that both the specimen cap 260 and the security cap 270 may be secured to the sampler body 210 by a variety of methods as previously discussed.

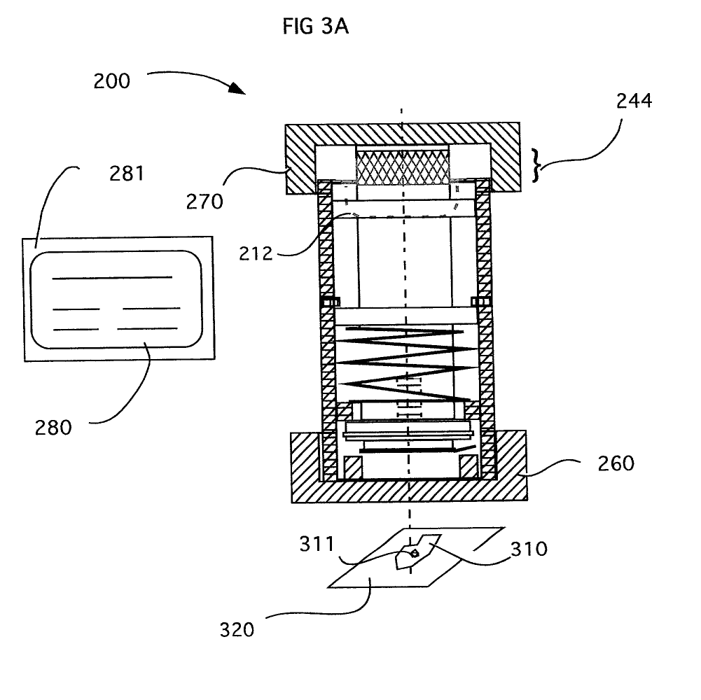

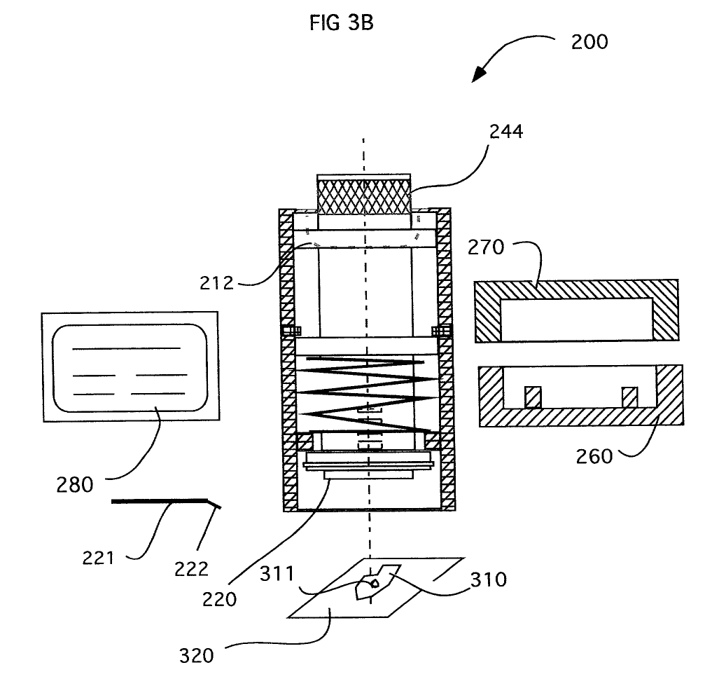

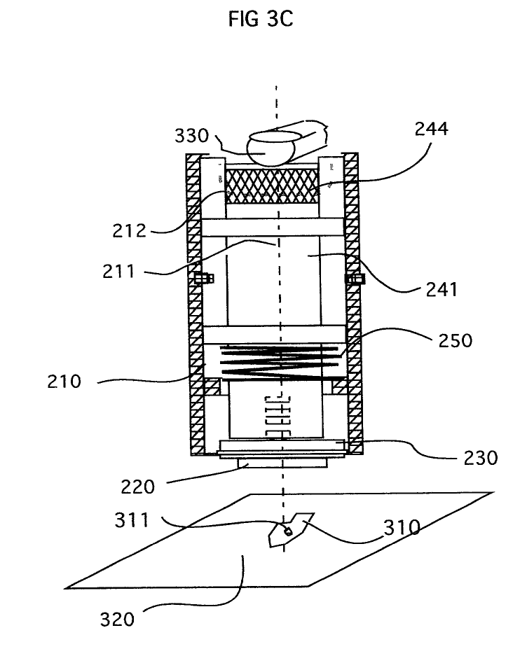

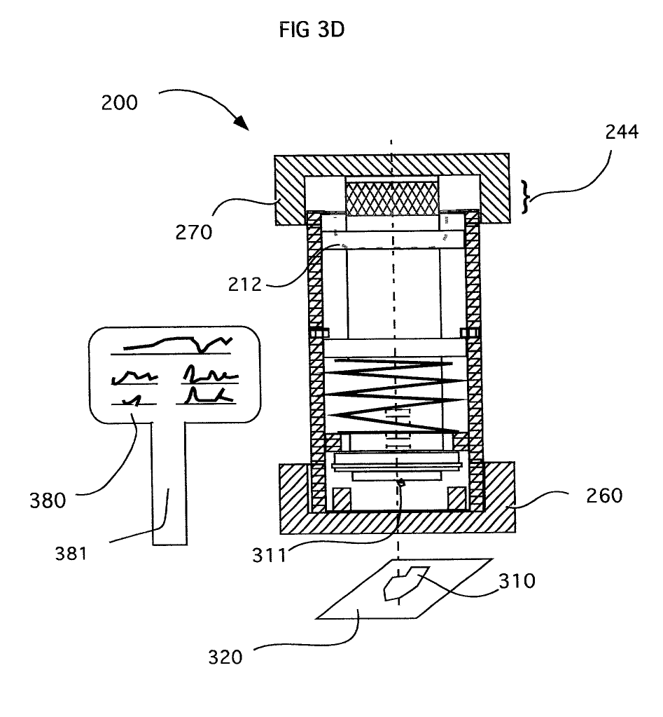

Referring now to FIG. 3A, illustrated is a partial sectional view of the sampler 200 of FIG. 2 as assembled and provided to a technician responsible for retrieving a specimen 311 of a suspected contaminant 310 from a surface 320. The security cap 270 is located over and coupled to the sampler body 210 so as to cover the finger access 212, thereby preventing inadvertent access to the knob 244. A self-adhesive identification label 280 comprises a backing 281 that covers the adhesive. The sampler 200 and identification label 280 may be provided as a preassembled kit or as individually packaged units to a technician or engineer who will acquire the specimen. Of course, specimen retrieval is not limited to manufacturing engineers but may also be performed by anyone sufficiently knowledgeable in the retrieval and handling of the specimen. The suspected contaminant 310 may be of almost any origin. Stainless steel from tool surfaces; flakes of deposited material, e.g., titanium from the chamber walls; reaction products from an incorrect process; traces from an incorrectly installed tool; etc. may each be found in a silicon semiconductor processing chamber.

Referring now to FIG. 3B, illustrated is a partial sectional view of the sampler 200 of FIG. 2 being prepared to retrieve a sample of a suspected contaminant 310 from the surface 320. The security cap 270 has been removed, exposing the finger access 212 and the knob 244. The specimen cap 260 and the removable seal 221 have been removed exposing the sampling medium 220. Of course, the removable seal 221 is not required for the present invention to perform its basic function, but the removable seal 221 may be used to provide a last measure of cleanliness to the sampling medium 220 until immediately before a specimen is to be taken. The security cap 270 and the specimen cap 260 are only generically shown. That is, the security cap 270 and the specimen cap 260 may be designed to be interchangeable or, alternatively, may be specifically designed to only fit the respective end of the sampler 200, as desired by the customer.

Referring now to FIG. 3C, illustrated is a partial sectional view of the sampler 200 of FIG. 2 just prior to retrieving the specimen 311 of the suspected contaminant 310 from the surface 320. The sampler body 210 has been placed proximate the suspected contaminant 310. In fact, the sampler body 210 will likely rest upon the surface 320, however, in the illustration the sampler body 210 and the surface 320 are shown separated for clarity. By pressing on the knob 244 with a finger 330, the spindle 241, platen 230 and sampling medium 220 are extended along the operating axis 211, compressing the spring 250, until the sampling medium 220 contacts the suspected contaminant 310. By the adhesive nature of the sampling medium 220, a specimen 311 of the suspected contaminant 310 is retrieved by the sampling medium 220. As pressure on the knob 242 is relaxed, the spring 250 retracts the platen 230, sampling medium 220, and specimen 311 into the sampler body 210.

Referring now to FIG. 3D, illustrated is a partial sectional view of the sampler 200 of FIG. 2 with a specimen 311 of the suspected contaminant 310. The specimen cap 260 has been replaced on the sampler body 210 thereby protecting the specimen 311 from contamination. The security cap 270 has been replaced on the sampler body 210 thereby preventing further access to the knob 244 and eliminating further exposure of the specimen 311. An alternative embodiment of an identification label 380 is shown and may be marked for identification either before or after applying the identification label 380 to the sampler body 210. In the illustrated embodiment, the identification label 380 has been filled in and is prepared to be applied to the sampler body 210. The identification label 380 further comprises a security tab 381 that may be applied over the specimen cap 260 in such a way as to further seal the specimen cap 260 to the sampler body 210, preventing the specimen cap 260 from dislodging and endangering the specimen 311 purity. Once the identification label 380 and security tab 381 are in place, the sampler 200 and specimen 311 are ready for transmittal to the analysis laboratory.

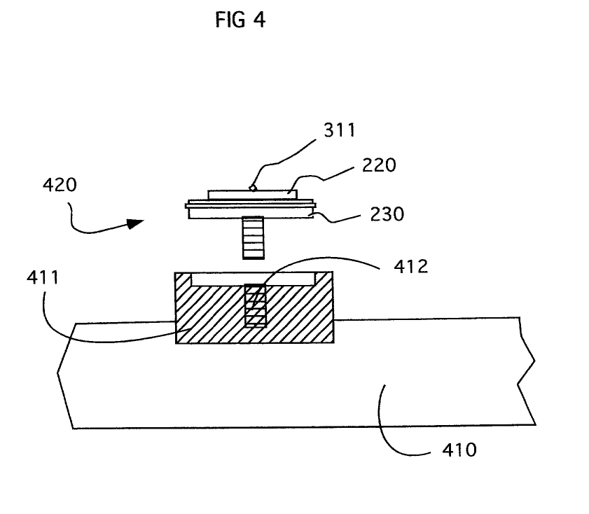

Referring now to FIG. 4, illustrated is an exploded partial sectional view of the platen 230, sampling medium 220, and specimen 311 after removal from the sampler body 210 and proximate a holder 411 for a generic analysis tool 410. In the illustrated embodiment, the platen 230 and mounting stud 233 may be collectively termed a sample holder 420. One who is skilled in the art is familiar with various analysis tools (not shown) and the methods of mounting specimens. In the illustrated embodiment, the mounting stud 233 couples to a matching threaded aperture 412. Of course, sample holder 420 may be configured as required to cooperate with other types of analysis tools as stated hereinabove.

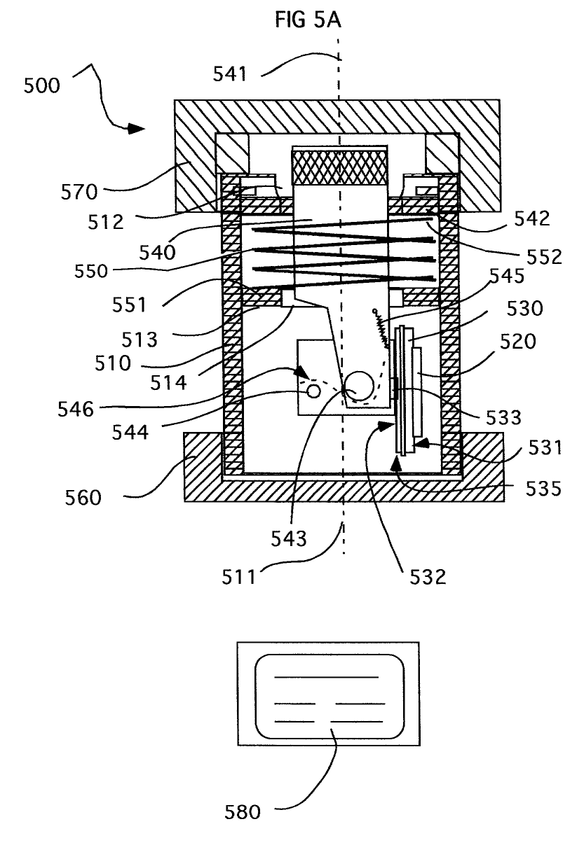

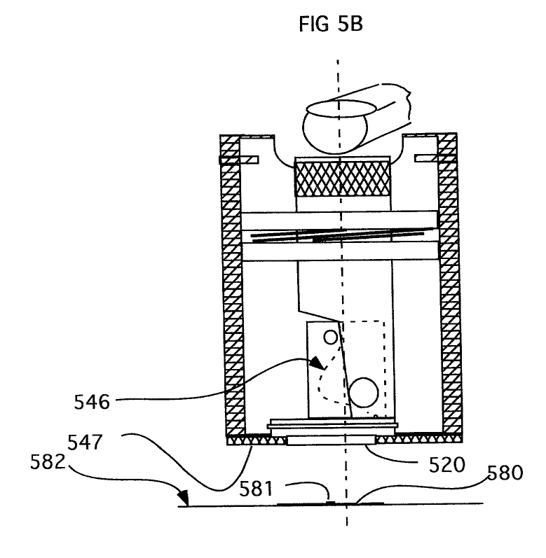

Referring now to FIGS. 5A and 5B, illustrated are partial sectional side views of an alternative embodiment 500 of the sampler of FIG. 1. FIG. 5A shows the sampler 500 as it would be stored and carried. FIG. 5B shows the sampler as it would be in use. In this embodiment, the sampler 500 comprises: a sampler body 510, a sampling medium 520, a platen 530, a plunger 540, a spring 550, a specimen cap 560 and a security cap 570. The sampler 500 is accompanied by an identification label 580 coupleable to the sampler body 510. The sampler body 510 has an operating axis 511 that is coincident with a longitudinal axis 541 of the plunger 540 when assembled. A finger access 512 is shaped in the sampler body 510. The sampler body 510 has an inner spring support 513 against which a first end 551 of the spring 550 bears. The plunger 540 passes through a plunger aperture 514 in the inner spring support 513. The plunger 540 has a spring stop 542 against which a second end 552 of the spring 550 bears. As in the previous embodiments, the sampling medium 520 comprises a double-sided tape or foil of silver, carbon, indium, copper, gold, or other suitable material.

Similarly, the platen 530 comprises a material such as: aluminum or plastic that is easily worked to a suitable configuration and that is easily identifiable and compatible with the intended analysis tool. The platen 530 comprises a first side 531 and a second side 532. The platen 530 further comprises at least one mounting system, e.g., a mounting stud 533, compatible with the intended analysis tool. Alternatively, the platen 530 may also incorporate other methods to mount to an analysis tool, e.g., external threads (not shown) about a periphery 535 of the platen 530, a specific periphery shape, etc. In fact, the platen 530 may be configured to be compatible with the mounting systems of more than one analysis tool, depending upon the specific mounting requirements of the various analysis tools that are available and that are mutually compatible.

The plunger 540 further comprises a bearing 543, a pivot 544, and an extension spring 545. Pivot 544 is fixed to the sampler body 510. When retracted, the bearing 543 bears against a bearing surface 546. As the plunger 540 is pushed downward, the bearing 543 rides against the bearing surface 546 thus rotating the platen 530 to the position as shown in FIG. 5B and exposing the sampling medium 520. A resilient gasket 547 allows the platen 530 to be rotated into position as shown in FIG. 5B about pivot 544 and then forced against a sample to obtain a specimen as discussed hereinabove. Alternatively, a retractable collar (not shown) may be formed about the sampler body 510 that allows the platen 530 and sample medium to rotate into position and then retracts as further pressure is applied to the plunger 540. One who is skilled in the art is familiar with such mechanisms.

The specimen cap 560 is removably coupleable to the sampler body 510 so that when the specimen cap 560 is removed, the sampling medium 520 is retracted within the sampler body 510, but capable of being exposed. The extension spring 545 urges the platen 530 to rotate toward the finger access 512 end of the sampler body 510 and away from the specimen cap 560 thus assuring that the sampling medium 520 does not inadvertently touch any surface not desired. The plunger 540 is coupleable to the platen 530 at the second surface 532 and the sampling medium 520 is coupled to the first surface 531. The plunger 540 is slidably coupled to the sampler body 510 in such a way that the plunger 540 slides along the operating axis 511 and the platen 530 rotates into the exposed position of FIG. 5B. When in place, the security cap 570 prevents access to the plunger 540 so that the platen 530 and the sampling medium 520 are prevented from inadvertent exposure and contamination. One who is skilled in the art will realize that both the specimen cap 560 and the security cap 570 may be secured to the sampler body 510 by a variety of methods as previously discussed.

To operate the sampler 500, the platen cap 540 is removed from the sampler 500 as shown in FIG. 5B and the sampling medium 520 pressed against the substance 580 thereby acquiring the specimen 581. After the specimen 581 has been acquired, the platen cap 540 is replaced on the sampler body 510 to protect the specimen 581 and sampling medium 520 from contamination. Thereafter, the entire sampler 500 and specimen 581 may be delivered/entrusted to a technician for laboratory analysis. In one embodiment, the platen 530 may be removable from the plunger 540 depending upon the attachment method. That is, the platen 530 may be screwed or mechanically coupled to the sampler body 510 in any way suitable. Of course, the mechanical method of protecting the platen and sampling medium discussed is only one of several ways that may be implemented to make use of the present invention by one who is skilled in the art.

Thus, a laboratory specimen sampler for collecting a specimen on a surface has been described that protects the sampling medium both before and after collecting the specimen. This enables a technician to quickly and neatly obtain a specimen that is preordained for analysis on a particular type of analysis tool while avoiding specimen contamination. The sampler is configured in such a way that the sampler protects the sampling medium or specimen storage and transport, yet the platen with sampling medium and specimen are easily removable and configured to couple readily with the desired analysis tool.

Although the present invention has been described in detail, those skilled in the art should understand that they can make various changes, substitutions and alterations herein without departing from the spirit and scope of the invention in its broadest form.

What is claimed is:

1. For collecting a specimen of a substance, a sampler, comprising:
a sampler body;
a platen having first and second opposing sides, the first side being removably coupleable to an end of the sampler body; and
a sampling medium coupleable to the second side and configured to retain a specimen of a substance thereon.

2. The sampler as recited in claim 1 further comprising a plunger slidably coupled to the sampler body and configured to removably couple to the platen.

3. The sampler as recited in claim 1 wherein the sampling medium comprises a foil of silver, carbon, indium, copper, or gold.

4. The sampler as recited in claim 1 further comprising a platen cap configured to removably couple to the sampler body proximate the platen.

5. The sampler as recited in claim 1 further comprising a rotatable platen coupled to the sampler body and configured to selectably expose the sampling medium.

6. The sampler as recited in claim 1 further comprising a specimen cap coupled to the platen.

7. The sampler as recited in claim 1 further comprising a spring interposed the platen and the sampler body, the spring configured to retract the platen within the sampler body.

8. The sampler as recited in claim 1 further comprising a security cap removably coupleable to the sampler body distal the platen.

9. The sampler as recited in claim 1 wherein the platen is configured to couple to an analytical tool.

10. The sampler as recited in claim 9 wherein the analytical tool is selected from the group consisting of:
a scanning electron microscope;
an Auger electron microscope;
a focused ion beam tool; and
an X-ray reflection diffractometer.

11. A method of manufacturing a sampler for collecting a specimen of a substance on a surface, comprising:
coupling a sampler body to a platen having first and second opposing sides at the first side; and
coupling a sampling medium to the second side, the sampling medium configured to retain a specimen of a substance thereon.

12. The method as recited in claim 11 further comprising slidably coupling a plunger to the sampler body, the plunger configured to removably couple to the platen.

13. The method as recited in claim 11 wherein coupling a sampling medium includes coupling a sampling medium comprising a foil of silver, carbon, indium, copper, or gold.

14. The method as recited in claim 11 further comprising coupling a platen cap to the sampler body proximate the platen, the platen cap configured to removably cover the platen.

15. The method as recited in claim 11 further comprising coupling a rotatable platen to the sampler body, the rotatable platen configured to selectably expose the sampling medium.

16. The method as recited in claim 11 further comprising coupling a specimen cap to the platen.

17. The method as recited in claim 11 further comprising interposing a spring between the platen and the sampler body, the spring configured to retract the platen within the sampler body.

18. The method as recited in claim 11 further comprising coupling a security cap to the sampler body distal the platen.

19. The method as recited in claim 11 wherein coupling a platen includes coupling a platen configured to couple to an analytical tool.

20. The method as recited in claim 19 wherein coupling a platen includes coupling a platen configured to couple to an analytical tool selected from the group consisting of:
a scanning electron microscope;
an Auger electron microscope;
a focused ion beam tool; and
an X-ray reflection diffractometer.
